(19) United States
(12) Patent Application Publication
(10) Pub. No.: US 2012/0028492 A1
(43) Pub. Date: Feb. 2, 2012

(54) CARD FOR INTERCONNECTING ELECTRONIC COMPONENTS USING INSULATED CABLE OR WIRE

(75) Inventor: Luis Rodrigo Del Aguila Aguilar, Tlalnepantla (MX)

(73) Assignee: Grupo Corporativo Nostrip S. De R.L. DE C.V. a corporation

(21) Appl. No.: 13/146,827

(22) PCT Filed: Apr. 2, 2009
(86) PCT No.: PCT/MX2009/000033

§ 371 Date: Oct. 11, 2011

(30) Foreign Application Priority Data
Jan. 28, 2009 (MX) A/2009/001077

(51) Int. Cl. H01R 4/24; H01R 43/00

(52) U.S. Cl. 439/391; 29/825

(57) ABSTRACT

A card for interconnecting electronic and electric components using cables or wires with associated sheathing comprises a casing made of insulating material and is provided with holes for accessing cavities which house lines composed of C-shaped connectors which are short-circuited together and lines composed of C-shaped connectors similar to those in the published patent Des. 235,554. Said access holes are arranged in two types of configuration. Lugs are provided at the ends extending along the width of the present card so as to allow the assembly of other cards of the same size which in this case house cylindrical or near-cylindrical objects (commercial pens). The card is insulated at the bottom by an insulating sheath with holes identical to the series of holes in the upper surface of the card. When interconnecting components with sheathed wire or cable a considerable amount of time is saved during wiring.

### FIELD OF INVENTION

Present invention refers to an existing fast wiring card known as protoboard, which is a tool with a method of use comprising attaching electric and electronic elements on surface boreholes, thus interconnecting to each other through copper wire or cable bridges to form a circuit. Said method requires measuring the distance between the terminals to be interconnected, adding the penetration distances in the protoboard for cutting the connection wire in order to prevent that wire remainders cause unnecessary noises and said method further requires removing the copper wire sheathing through cutting clamps or other tools. Prior method though effective, requires a significant time and work investment by interconnecting several terminals of a number of elements, as is very common.

### BACKGROUND OF INVENTION

Products currently used for interconnecting low power electronic and electric components largely resemble the card published in Des. patent 235,554. Electronic components are assembled in this card by inserting them in the access boreholes located on card surface, to electric lines formed by clips made of conductive material with shape memory located in cavities in the bottom part of the card. Said clips are formed in sets of five separated from their centers at a distance of 2.54 mm. Upon being these components assembled, they are interconnected through copper wire bridges which have to be cut at an existing distance between terminals intended to be connected plus the penetration distance from bridges into clips; when the bridge is cut the sheathing is removed at a distance equivalent to that of bridge penetration into clips. The assemblable card accordingly with others from the same size, has two types of arrangement: One of terminals and another of power. The terminal arrangement comprises sixty four sets of five clips separated 2.54 mm with respect to their centers, forming separated alignments at 2.54 mm each other and being present among them a portion of insulating material which is part of the electronic card this forming a connector grid. This arrangement is symmetrically repeated with respect to an imaginary card axis cutting it in equal sizes with respect of its length, said plane is located at 3.81 mm from the center of the first card accesses respective at each side, moving from center to outside thereof. The power arrangement comprises four alignments, to at each end of the card, one being ground and another power, from five sets in short-circuit for each alignment, each set formed by five clips separated at 2.54 mm with respect to their centers; This arrangement is symmetrically repeated with respect to an imaginary card axis cutting that equally with respect to its width. This card has a groove running along it in order to ease extracting assembled integrated circuits over the surface thereof. There are variations in this card model with smaller versions thereof and with unassemblable power terminals.

Published patents along time belonging to the same field of invention than protoboard, have only change the length, arrangement and size of said device, however the method whereby electronic circuits are assembled has not changed when using this tool, often representing more time and work invested in the task of wiring a multiple terminal circuit. The following problems are derived from the intrinsic method to the use of this wiring tool and its design:

The cable forming the connection between two terminals shall be measured to the right size and the penetration distance from the bridge to the corresponding clips on each terminal is empirically added. This operation consumes time, which shall be multiplied by the number of interconnections which may be multiple and they may further follow intricate paths which should be sectioned, thus increasing the time in this operation because of the sections to be interconnected.

Cable sheathing must be removed with cutting clamps or with any other cutting tool. This operation takes time, which must be multiplied by the number of connected terminals which may be multiple and that may further follow intricate paths to be made in sections, therefore increasing the time of this operation because of the section terminals to be interconnected.

More resources must be invested in tooling for wiring an electronic circuit as two clamps are required for performing the action of removing the copper wire bridge sheathing; some for wire fixing while the sheath is removed and other cutting clamps for removing the sheath.

Circuit reading and understanding is difficult when time is intended to be saved by obviating the step of measuring the distance between terminals. Although this solution for saving time is attractive, it sacrifices presentation in final wiring work making difficult the task of reading the circuit in case that a new Reading is required, thus spending even more time. Moreover, electronic noise may be generated by using this solution.

Tightening force is not sufficient to ensure that the wire bridge is fixed in its site because of clip design. This problem may cause a loss of connections between terminals if the wired circuit in the card intends to be transported in backpacks not designed for this purpose.

Because of the handcrafted wiring method, exposed parts caused by excessive removal of the sheath are not ensured to prevent an accidental short-circuit if the circuit is intended to be handled while energized. In this case, accidental electric discharges to the users may be generated in turn upon touching the circuit surface when energized.

Prior art card shows designs in a single piece and in three pieces, the latter comprising an element in terminal arrangement and two elements in power arrangement. Those of power comprise elements useful as links for assembling two terminal arrangements of identical sizes, therefore, three power and two terminal elements are required for this assembly. In case the remaining power terminal in the assembly is lost, the set of three pieces comprising one of the two previously assembled cards would be lost.

These problems in practice cause economic and time losses, those which may be present from academic environment until research and development of electronic and electric products. Due to competitiveness issues and a current globalized environment time and resources should be optimized in order to support achieving the purposes of students, researchers and product developers involving electronics.

Following are cited some U.S. patents with the most significant developments in the field of the present invention, including prior art.

| Pat. | |
|---|---|
| No. | Inventor |
| 3,085,177 | Thompson |
| 4,129,349 | von Roesgen |
| 4,475,782 | Bartolf |
| 4,522,449 | Hayward |
| 4,791,722 | Miller Jr. |
| 5,309,327 | Slater |
| 7,081,591 | Swetland |
| Des. 235,554 | Portugal |

### SUMMARY OF INVENTION

It is the purpose of present invention to solve the problems generated for users by the use of prior art card and its intrinsic operation method, those which have been disclosed in above section.

It is the first intention of present to provide a user with a new connection method of electric, electronic and digital components by providing a new interconnection card of electric and electronic components which terminal legs are inserted into the access boreholes to C-shaped connector clamps or similar but not identical, connector clamps to those in published patent Des. 235,554 (as shown in FIG. 1) each made of conductive material and each in turn a component of conductive lines. Said holes are located on the upper surface over the casing of present invention. This method is characterized by allowing the user to identify the clamp of any type of connector which will receive the component terminal leg so that the user is able to insert fully confident the component when the connector is similar but not identical to that disclosed in published patent Des. 235,554 or otherwise when dealing with a C-shaped connector care should be taken for inserting the component terminal leg located above of the C-shaped connector ratchet mechanism blade and not passing said leg through said ratchet blade as the action of pulling again the component when making that mistake will cause a possible damage in the ratchet mechanism blade on said C-shaped connector. Component terminals are assembled to each other by copper wire or cable bridges inserted in the card as corresponding to each end at a terminal.

It is another purpose of present invention to provide user with a new connection method at the time of connecting a copper wire or cable end without removing the sheath to a terminal wherein previously made connections made of insulating material are present over the casing surface in this invention. Said connection serves as a support for measuring node voltage or for transmitting a signal or energy to said components. This method is characterized by allowing to said user savings in the task of remover el copper wire or cable sheathing with clamps or with other tooling designed for this task at said end and so allowing to insert and to push into the corresponding connection terminal the copper wire or cable with sheath after pulling in opposite direction to pushing and thus achieving a successful connection between the copper wire or cable end and the corresponding C-shaped connector (as shown in FIG. 2). This method feature is possible because of the guide cavity design in the C-shaped connector housing located in the casing inner part and due to a ratchet mechanism blade in the C-shaped connector itself. These elements create a connector mechanism by recess in the wire bridge.

It is another purpose of present invention to provide to the user with a new connection method at the time of interconnecting the electric, electronic, node elements formed by a combination thereof or any combination of the three previously assembled over the casing surface made of insulating material in this invention, with copper wire or cable bridges. This method is characterized by allowing to said user savings in the task of removing a copper wire or cable sheathing with clamps or with other tooling designed for this task and so allowing to insert and to push in the corresponding connection terminal the copper wire bridge with the sheath after pulling in opposite direction to pushing and with this achieving a successful connection between the bridges and the C-shaped connectors (as shown in FIG. 3). It is possible with this time savings caused by the fact of having to remove said sheath. This method feature is possible because of the guide cavity design in the C-shaped connector housing located in casing inner part and due to the ratchet mechanism blade in the C-shaped connector itself. These elements form a connector mechanism by a recess in the wire bridge.

It is another purpose of present invention to provide user with a new connection method at the time of interconnecting the electric, electronic, node elements formed by a combination thereof or any combination of those three, previously assembled over the casing surface made of insulating material in this invention, with copper wire or cable bridges. This method is characterized by allowing to said user savings in the task of measuring the distance between the corresponding connection terminals to each electronic, electric element, node or any combinations of those three, so allowing to insert the copper wire bridge or cable and passing it by pushing said wire starting from an access borehole in the upper surface of the present invention to its bottom surface after pulling the protruding part from the bridge in the bottom part of the card towards the first push used to pass said sheathed wire or cable through the body of the present invention, said operation being repeated twice, one per point at each corresponding element or node terminal (as shown in FIG. 4); This method feature is possible because of the guide cavity design in the C-shaped connector housing in the casing inner part, because of the ratchet mechanism blade and guide borehole in the C-shaped connector and because of the respective guide boreholes in the short-circuiting elements and forming connector lines of multiple C-shaped connectors among them or other type of lines formed by a similar connector as those described in published patent Des. 235,554 with four C-shaped connectors. These elements form a passing guide for bridging wire to save measurement.

It is another purpose of present invention to provide user with a new fixing method for cutting at the time of removing the remaining by the fact of interconnecting the electric, electronic, node elements formed by a combination thereof or any combination of those three, previously assembled over the casing surface made of insulating material in this invention, with copper wire or cable bridges. This method is characterized by allowing said user to cut with clamps or with any other tool the remaining wire at such a measure which is of the required accuracy to perform the connection between the corresponding terminals to two electric, electronic, node components or any combination of those three, this as a later step of having inserted, pushed and pulled by the bottom part of the present invention and then pulling by the upper part the interconnection wire simultaneously by its two ends or one at a time (as shown in FIG. 5). This method feature is possible because of guide cavity design in the C-shaped connector housing within the body of the card which allows passing the terminal bridge wire through its body thanks to the ratchet mechanism blades in the C-shaped connectors housed in their respective cavity. These form a fixing mechanism which fixes the bridge wire or cable while proceeding to cut the remaining copper material.

It is another purpose of present invention to provide user with a new stretching method of sheathed wire or cable at the time of interconnecting the electric, electronic, node elements formed by a combination thereof or any combination of those three, previously assembled over the casing surface in this invention, made of insulating material, with copper wire or cable bridges or at the time of intending to get a node for voltage measurement or power supply. This method is characterized by allowing said user to straighten the twisted wire length used upon stretching in opposite direction to the insertion and push direction previously performed for interconnecting one of the corresponding terminals to two electric, electronic, node components or any of the combinations of these cases (as shown in FIG. 6). This method feature is possible because of the C-shaped connector ratchet mechanism blade in conjunction with the guide cavity in the C-shaped connector housing located within the insulating material card. Both elements form a ratchet mechanism fixing the wire in position while the user performs the wire stretching with the fingers.

It is another purpose of present invention to provide user with a new unplugging method at the time of removing the interconnections between the electric, electronic, node elements formed by a combination thereof or any combination of those three, previously assembled over the casing surface in this invention, made of insulating material, with copper wire or cable bridges. This method is characterized by allowing the user to cut by the upper part of the present invention the wire or cable connection bridge and pulling the two resulting cutting parts by the bottom part of the card (as shown in FIG. 7). This method feature is possible because of the guide cavity in the C-shaped connector housing in the casing inner part, because of the ratchet mechanism blade and guide borehole in the C-shaped connector and because of the respective guide boreholes in the short-circuiting elements and forming connector lines of multiple C-shaped connectors to each other or another type of lines formed by a similar connector to those disclosed in the published patent Des. 235,554 with four C-shaped connectors. These elements form a passing guide for bridging wire to perform the cutting.

It is another purpose of present invention to provide user with a new assembly method between identical size cards for assembling circuits exceeding the housing capacity of each individually, this method is characterized by allowing the user to assembly with cylindrical bodies (as shown in FIG. 8) two or more cards by the lugs which are in the ends running freely in present invention. Said cylindrical bodies have a diameter equivalent to a circle within the hexagon belonging to the cross section of a standard pen, thus in case of losing one of the two card cylindrical bodies a replacement may be performed with a standard pen to perform said assembly.

The present invention consists of a new wiring card including all parts described in above paragraphs of the assembly method of electric and electronic components, the method of interconnection of intrinsic components thereto and the assembly method between cards. The main components of this card are: insulating casing, connection lines for power arrangement, connection lines for terminal arrangement and insulating sheath of the bottom part (as shown in FIG. 9). This card has holes of two types over the upper surface accessing to the connector line housings, located within the body thereof), these holes go directly to the fixing clamps at each of the connectors in each line (as shown in FIG. 10 and FIG. 11). In the housings composed lines are exclusively assembled of C-shaped connectors in short-circuit among them (connection line in power arrangement) and composed lines of C-shaped connectors and similar to those from published patent Des. 235,554 (connection line in terminal arrangement); Said access boreholes are disposed in two types of arrangement: terminals and power. The power arrangement comprises four multiple hole alignments, locating those four in one end of the card in subgroups of two each longitudinally arranged wherein each subgroup alignment separates each other at 2.54 mm on card width; In a subgroup of two, one alignment has the purpose of being the ground terminal and the other the power one; On each alignment the holes enter into the line housed in a cavity, wherein said line exclusively comprises C-shaped connectors (one connector per each access borehole) of conductive plated material and with shape memory, separated at 5.08 mm each other along said alignment and in short-circuit to each other by a conductive element made of the same plated material; the C-shaped connectors are assembled to the short-circuiting element by microwelding; the two subgroups in this arrangement are symmetrically repeated with respect to an imaginary plane in the card cutting the same evenly with respect to its length. The terminal arrangement comprises multiple alignments separated to each other at 2.54 mm comprising six access boreholes such spaced that form subgroups of three each wherein each hole in each subgroup is spaced at 2.54 mm and 5.08 mm respectively with respect to their centers, each subgroup being separated each other at 5.08 mm along the alignment, said access boreholes entering into composed lines of four C-shaped connectors separated each other at 5.08 mm and one similar to that from published patent Des. 235,554, made of conductive plated material and with shape memory, in short-circuit to each other by a conductive element made of the same plated material, the C-shaped connectors and those similar but not identical to those published in the Des. patent 235,554, and assembled to the short-circuiting element by microwelding. This arrangement is symmetrically repeated with respect to an imaginary plane in the card which cuts evenly itself with respect to its length, said plane is located at 3.81 mm from the center of the first accesses in the card respective at each side, from the center towards outside thereof (as shown in FIG. 12). There are two types of cavity, one type per arrangement; One cavity for the line in power arrangement wherein each of the subcavities houses a single C-shaped connector and which access boreholes are of large size. The type of cavity in turn for the terminal arrangement wherein its subcavities are of three types: three of a single type for housing each a C-shaped connector which access boreholes are of large size, one of another type for housing a C-shaped connector which access borehole is of regular size with extension grooves for inserting the widest part to the integrated circuit legs in plastic enclosures and one subcavity of another type for housing a similar connector but not identical to that from published patent Des. 235,554, which access boreholes are of regular size and with extension grooves for inserting the broadest part of the integrated circuit legs in plastic enclosures (these cavities are shown in FIG. 13). The large size access boreholes in the card are designed to insert components into them with thick legs that would not easily enter into the wiring card from prior art unlike the regular size access boreholes which are designed to insert on them components with moderate thick legs and with extension grooves in the holes, for inserting the widest part of the integrated circuit legs in plastic enclosures (as shown in FIG. 14). In the insulating material casing, the first type of C-shaped connector housing subcavity, located in the housing cavities for lines in terminal arrangement and lines in power arrangement, is characterized by having three properties; One to follow a curvature for the connector ratchet mechanism blade which radiuses are designed to dissipate the stored power in the connector and being possible to recover the prior shape to inserting a copper wire bridge; the other property is a groove wherein the C-shaped connector clamp is housed having a parallelepiped shape with two nearly-cylindrical grooves from the guide for the copper wire with its sheath; the third property is a guide cavity for the copper wire bridge forming a pipe cut by a parallelepiped which houses the C-shaped connector clamp and having a hole in the upper part which radius is of the same size than the pipe, thus forming a C-shaped connector housing with large size access borehole. The other type of C-shaped connector housing subcavity, only present in the line housing cavity in terminal arrangement, is characterized by having the same three properties than the prior housing except for the hole in the pipe upper part being of regular size with its extension grooves. The connector housing subcavity similar but not identical to that from published patent Des. 235,554 only present in the line housing cavity in terminal arrangement, is characterized by having two parallelepiped bodies touching the connector, those which do not interfere with the electronic component connection and located one at each void parallelepiped cross wall forming the housing subcavity of this connector type and two nearly-parallelepipedal bodies wherein a hemi-cylindrical groove runs which is an extension of the hole located in the card upper part; said nearly-parallelepipedal bodies are each located on each longitudinal wall of the void parallelepiped comprising the housing subcavity of this connector type (that being shown in FIG. 15). For the purpose of product aesthetics, diamond-shape concave surfaces are located on the holes in present card surface which main axis is aligned with respect to each respective alignment to each arrangement whether terminals or power and which axis intersection matches with access boreholes axis at the connector line housings (as shown in FIG. 16).

The new wiring card from present application, including all parts described in above paragraphs of the assembly method of electric and electronic components, the method of interconnection of said components and the part of the assembly method intrinsic thereto, made of a single piece, made of insulating material which has lugs being in the ends running all across the present card for assembling other cards of the same size which as such house cylindrical or other near-cylindrical bodies which may comprise pencils or pens. Said lugs have card bottom surface separated from the standing surface in order to provide that the protruding parts from the connection wire bridges in the bottom part do not withstand the wiring card and separate them from the floor (as shown in FIG. 17).

The new wiring card from present application including all parts described in above paragraphs of the assembly method of electric and electronic components, the method of interconnection of said components intrinsic thereto, made of a single piece, made of insulating material having a groove running along the card in its central part and with the purpose of extracting integrated circuits in plastic enclosures and with legs completing an even number (as shown in FIG. 18).

The card also comprises one casing made of insulating material with cavities housing two types of connector lines and with access boreholes arranged in two types of arrangement, some of regular size with extension grooves and others of large size; Said holes are accesses to each of the connector clamps of mentioned lines and housed in their cavities. Said casing has lugs in the ends running all across and one groove in turn running along the card by its central part. Said casing has free regions on each cavity for housing lines whether terminal or power, where a short-circuiting element adheres to each connector respectively at each line (as shown in FIG. 19 and FIG. 20).

The card also comprises a sheath adhered to the bottom part of the card made of insulating material keeping connector lines from exposure, having outlet holes for the copper wire bridges following an identical arrangement to that from the holes in the upper surface of the casing card made of insulating material (as shown in FIG. 21). In the assembly, the holes in this sheath match with the holes in the card upper part.

The card also comprises a new line type in terminal arrangement, comprising four C-shaped connectors made of conductive material, plated and with shape memory, arranged in such a line that each one is separated at 5.08 mm each other with respect to a fixing clamp in its geometry and a similar connector to that from Des. patent 235,554 with two fixing clamps separated 2.54 mm each other; This connector being similar to that from published patent Des. 235,554 separated at 2.54 mm with respect to one of its clamps and the closest C-shaped connector clamp. Therefore, there are six clamps, three of them separated at 5.08 mm and three of them separated at 2.54 mm wherein each subgroup of three clamps in the alignment is separated at 5.08 mm. Said five connectors are short-circuited through an element made of conductive material, with shape memory and plated, in such arrangement that the four C-shaped connectors are in series keeping their orientation along the line and with their central imaginary cutting said C-shaped connector symmetrically, matching with the imaginary plane cutting in its longest side and symmetrically to the element short-circuiting the five elements; The axis in four holes in turn, arranged along the short-circuiting element to the five connectors, matches with above mentioned guide boreholes in the body of each C-shaped connector; A similar connector to that from published patent Des. 235,554 is present in turn, located in a region where no hole is present, which central imaginary plane cuts said conductor symmetrically in its longest part, matching with the imaginary plane cutting in its longest side and symmetrically to the element short-circuiting to the five elements. The element short-circuiting to the five connectors and forming one line, has free regions at the sides and one in the part between the closest C-shaped connector to the similar but not identical connector to that from published patent Des. 235,554, so that these latter regions may adhere to some free regions in the casing housing. The two-type five connectors are assembled to the short-circuiting element by microwelding (as shown in FIG. 22). The number of lines in terminal arrangement varies in a direct relationship with the casing length which cavities house these types of lines in terminal arrangement.

The card also comprises a new line type in power arrangement comprising multiple C-shaped connectors made of conductive material, plated and with shape memory, arranged in one such line that each one is separated at 5.08 mm each other with respect to a fixing clamp in its geometry. Said multiple connectors are short-circuited through a component made of conductive material, with shape memory and plated, in such arrangement that the multiple C-shaped connectors are serried keeping their orientation along the line and their central imaginary plane cutting symmetrically said C-shaped connector, matches with the imaginary plane cut on its longest side and symmetrically to the short-circuiting element at the multiple C-shaped connectors; The axis in the multiple guide boreholes arranged along the element short-circuiting to the multiple C-shaped connectors and having a number which is the same as the number of said C-shaped connectors, is in turn matched with the above mentioned guide boreholes in the body of each of said C-shaped connectors. The element short-circuiting to the multiple connectors and forming the line, has free regions at the ends so that the latter may adhere to some free regions in the card housing. The multiple C-shaped connectors are assembled to the short-circuiting element by microwelding (as shown in FIG. 23). The length of the line in power arrangement and thus the number of C-shaped connectors to be short-circuited, varies in direct relationship with the length of the casing which cavities house these types of lines in power arrangement.

The card also comprises a C-shaped connector made of conductive material, plated and with shape memory, made of a single piece, corresponding to the constituting elements of the present invention mentioned in the two last paragraphs, with three main constituting elements: fixing clamp, ratchet mechanism blade and guide borehole. The ratchet mechanism blade comprises a sharp corner and with bend radiuses constituting a curvature in the geometry thereof; the radiuses are designed for dissipating the stress exerted by deformation upon inserting the copper wire bridges with sheath. The fixing clamp comprises two curved side elements, symmetrical and in opposite position each other, the curvature in the geometry of each element has radiuses designed for dissipating the stress exerted deformation upon inserting a number of electronic, electric components and the copper wire bridges with sheath. The guide borehole crosses the hemi-flat region located between the constituting elements of the fixing clamp; since because of its radius size, the region between the clamps is not sufficient for housing it, and is supported by a square region in the material for this purpose (as shown in FIG. 24).

The card also comprises a similar connector but not identical to that from published patent Des. 235,554 made of conductive material, plated and with shape memory, made of a single piece formed with two fixing clamps, each comprising two curved side elements, symmetrical and in opposite position each other, the curvature in the geometry of each of the elements has radiuses designed for dissipating the stress exerted by deformation upon inserting the number of electronic and electric components (as shown in FIG. 25); Said clamps are separated at 2.54 mm each other.

The card also comprises a conductive element, plated and with shape memory, made of a single piece, short-circuiting to multiple C-shaped connectors, with a body having multiple holes with the same number than the C-shaped connectors to be assembled in their surfaces by microwelding, said holes crossing from the upper to the bottom face; These holes are separated at 5.08 mm each other and are such arranged that their axis match with the plane cutting said short-circuiting element symmetrically in its longest part. This element has free regions at the ends for assembling by adhesion the line formed by the action of short-circuiting the connectors to the insulating material casing (as shown in FIG. 26).

The card also comprises a conductive element, plated and with shape memory, made of a single piece, which short-circuits to four C-shaped connectors and one similar but not identical to that from published patent Des. 235,554, to be assembled in their surface by microwelding. There are four holes in its body crossing said short-circuiting element from its upper surface to its bottom surface, said holes are separated at 5.08 mm each other and such are arranged that their axis match with the plane cutting said short-circuiting element symmetrically in its longest part. There is also a flat region on its surface designed to house a similar but not identical connector to that from published Des. 235,554. This element has free end regions and one in the region where a C-shaped connector and one similar to published patent Des. 235,554 to assemble by adhesion the line formed by the action of short-circuiting the connectors to the insulating material casing (as shown in FIG. 27).

### BRIEF DESCRIPTION OF THE DRAWINGS

FIG. 1 shows a cross section of the electromechanical interconnection card between electric, electronic, node components or any combination of those three, corresponding the present invention, along a terminal arrangement line with assembled and evenly sectioned components.

FIG. 2 shows a cross-section of present card along a line in terminal arrangement, wherein a blade in a C-shaped connector is shown cutting the copper wire, which may be also a cable, sheath inserted into the card and forming a recess in said wire or cable.

FIG. 3 shows a cross-section of present card along a line in terminal arrangement wherein two C-shaped connectors are shown performing the action shown in FIG. 2, forming a recess in the ends by each connector in the same wire which may be also a cable.

FIG. 4 shows a cross-section of present card along a line in terminal arrangement, wherein a copper wire bridge with sheath is shown, which may be also a cable, inserted into the card wherein the C-shaped connector blades do not cut the wire sheath nor form a recess therein.

FIG. 5 shows a cross-section of present card along a line in terminal arrangement, wherein se shows un copper wire, which may be also a cable, bridge inserted into the card with bottom parts cut such as their remaining being separated.

FIG. 6 shows a cross-section of present card along a line in terminal arrangement wherein a copper wire end, which may be also a cable, is shown being pulled in such direction starting from the bottom part of the card to the upper part thereof.

FIG. 7 shows a cross-section of present card along a line in terminal arrangement wherein a copper wire bridge, which may be also a cable, is shown being cut in card upper part side and which resulting ends are being pulled in such direction starting from the card upper surface to the bottom part thereof.

FIG. 8 shows two cards being assembled by a standard pen and by a cylindrical element with a length similar to the width of any of the cards.

FIG. 9 shows a view wherein all the constituting components of present wiring card may be observed and which main components are, insulating material casing with special cavities, terminal arrangement lines, power arrangement lines and drilled sheath from the bottom part.

FIG. 10 shows a cross-section of present card in its longest part showing any electric or electronic element leg, being inserted in one of the access boreholes and therefore opening one of the clamps in a connector similar but not identical to that from published patent Des. 235,554 in said figure.

FIG. 11 shows a cross-section of present card in its longest part showing any electric or electronic element leg being inserted in one of the access boreholes and therefore opening the C-shaped connector clamp in said figure.

FIG. 12 shows two secciones in present card, one along one of the power arrangement lines and another along the lines in opposite position in terminal arrangement.

FIG. 13 shows the bottom part of the card without the insulating sheath which is adhered to the bottom part, showing in turn one of the power arrangement lines and one of the terminal arrangement lines disassembled from said card.

FIG. 14 shows several electric, electronic components and copper wires assembled over the card surface wherein one of the IC (integrated circuit) legs is protruded showing its insertion in an extension groove in the respective hole.

FIG. 15 shows the card without the bottom part insulating sheath wherein a cross section of present card is shown along one of the terminal arrangement lines; the subcavity surfaces housing the C-shaped connectors are also shown, wherein said subcavity is part of a cavity housing a terminal arrangement line. The four C-shaped connectors and the similar but not identical connector to that from published patent Des. 235,554 are also shown without the short-circuiting element to said connectors. The protruded peripheries of three regular size access boreholes with their respective extension grooves and the protruded periphery of one of the large size access boreholes are also shown.

FIG. 16 shows part of the upper surface of present card with diamond-shape details with ornamental rounded corners in present card. Part of the groove running by the longest part of present card is also shown.

FIG. 17 shows present wiring card resting on a flat surface.

FIG. 18 shows an assembled IC (integrated circuit) over the surface of present wiring card wherein one of the access boreholes of said card corresponds to each leg.

FIG. 19 shows the casing of present electromechanical interconnection card in its bottom part, showing the terminal arrangement line and power arrangement line housing cavities.

FIG. 20 shows the present electromechanical interconnection card casing in its upper part showing the access boreholes to the terminal arrangement line and power arrangement line housing cavities.

FIG. 21 shows the sheath adhered to the bottom part of the card.

FIG. 22 shows one line in terminal arrangement with its constituting elements: four C-shaped connectors, a similar connector but not identical to that from published patent Des. 235,554 and an element short-circuiting to above mentioned elements.

FIG. 23 shows one line in power arrangement with its constituting elements: multiple C-shaped connectors and one short-circuiting element.

FIG. 24 shows a C-shaped connector with its constituting elements: clamp, guide borehole and ratchet mechanism blade.

FIG. 25 shows a similar connector but not identical to that from published patent Des. 235,554 with the two clamps comprising it.

FIG. 26 shows a short-circuiting element for multiple C-shaped connectors forming a power arrangement line.

FIG. 27 shows an element short-circuiting to four C-shaped connectors and one similar but not identical to that from published patent Des. 235,554 as to form a terminal arrangement line.

### DETAILED DESCRIPTION OF INVENTION

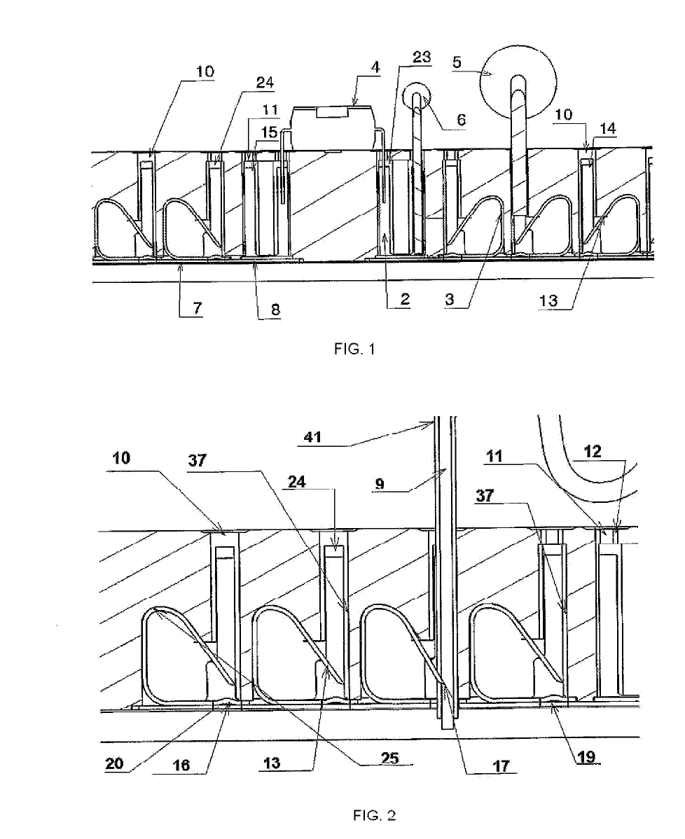

FIG. 1 shows a cross view of present card with a number of connected components: resistance (6), diode (5), and one IC (4). Said components are inserted by the large size access boreholes (10) and by regular size access boreholes (11) being on casing surface of present card (1). Upon intending an interconnection of electric or electronic components, they are inserted into the C-shaped connectors (14) clamps or in the clamps of similar connectors to those from prior art (15), being opened and in such opening each clamp leg is housed in the opening and housing grooves of the C-shaped connector (24) clamp, and in the opening and housing grooves of a connector clamp similar but not identical to that from prior art (23) in the casing (1), accordingly; this being performed on each side, each leg and each clamp. In said figure the clamp action of a connector to that from prior art (2) is shown and one C-shaped connector (3) which are short-circuited together with another three C-shaped connectors (3) by a terminal distribution sheet (7) short-circuiting them, then as being conductive and being in contact with a terminal in said components, said terminals are consequently interconnected. Upon connecting the electric and electronic elements care is taken of preventing connection until the guide borehole (16) in C-shaped connectors (3) elements such as resistors (6) and diodes (5) and similar which are characterized by having a physically larger body than the large size access borehole (10) and neither in the ratchet mechanism blade (13) as the latter would make a recess in the inserted element terminal leg so that when removing again the element, the recess in the inserted component would be part of a ratchet mechanism making impossible a proper removal and damaging the C-shaped connector (3) ratchet mechanism blade (13). This is not present in case of a connector similar but not identical to that from prior art (2) wherein components may be inserted and removed without concern of any disarrangement in said connector. The insulating bottom closure (8) insulates the conductive elements within the outer card. State disclosed in the paragraph is also represented in FIGS. 10 and 11.

In FIG. 2 a copper wire (9), which may be also a cable, with sheath (41) is shown inserted into a large size access borehole (10), which may be also inserted into a regular size access borehole (11) within the same alignment. The copper wire or cable (9) has a recess (17) in its body made firstly by the action of inserting and then pulling the cable (9) with sheath (41) in opposite direction to initial insertion, which when inserted into said hole (10) opens the C-shaped connector (3) clamp (14) as shown in FIG. 11 wherein each leg when opened is housed in the housing and opening groove of C-shaped connector (24) clamp. In turn, when meeting with ratchet mechanism blade (13) upper surface, it tends to move against the opposite wall to said blade, which is part of the stretched cable guide groove (37). Advantage is taken from the fact that sheath material (41) is quite less hard than the ratchet mechanism blade (13) material pressing cable (9) with sheath (41) against the stretched cable (37) guide groove wall; in this state the sharp corner presses the sheath (41) without incrusting therein and thus cutting is not caused. Said state remains until the cable (9) with sheath (41) is pulled so that the ratchet mechanism blade (13) sharp corner is incrusted into the sheath (41) due to differences in hardness and causing a cut in said sheath. Upon having a cut in the sheath and by continuing pulling the cable in opposite direction to that from initial insertion, the sheath uncut part, having sufficient material for contacting blade face, pushes upwards the ratchet mechanism blade (13), this being in conjunction with the opposite reaction in the C-shaped connector (25) housing subcavity, the ratchet mechanism blade (13) is incrusted into the copper wire or cable forming a recess (17) therein. As the C-shaped connector (3) and the cable or wire (9) is made of conductive materials, an electric connection is performed between said components. In order to properly perform this operation, the cable or wire (9) with sheath (41) passes through a guide borehole in the C-shaped connector (16), also through the guide borehole in the sheet short-circuiting the connectors in terminal (19) or power (42) distribution accordingly, and through the hole in the insulating closure (20), before pulling said cable (9) with sheath (41) in opposite direction to the initial insertion. The cable (9) with sheath (41) has sufficient rigidity to be inserted by the corresponding access borehole and pushed by the still non-inserted part from that cable or wire (9) so that the C-shaped connector (14) clamps and the ratchet mechanism blade (13) are temporarily deformed, which may turn back to their original shape provided the material shape memory and the housing and opening groove (24) design of C-shaped connector (3) and also the C-shaped connector housing subcavity (25) exerting their reaction forces in the necessary points for recovering C-shaped connector (3) its original shape upon performing its function.

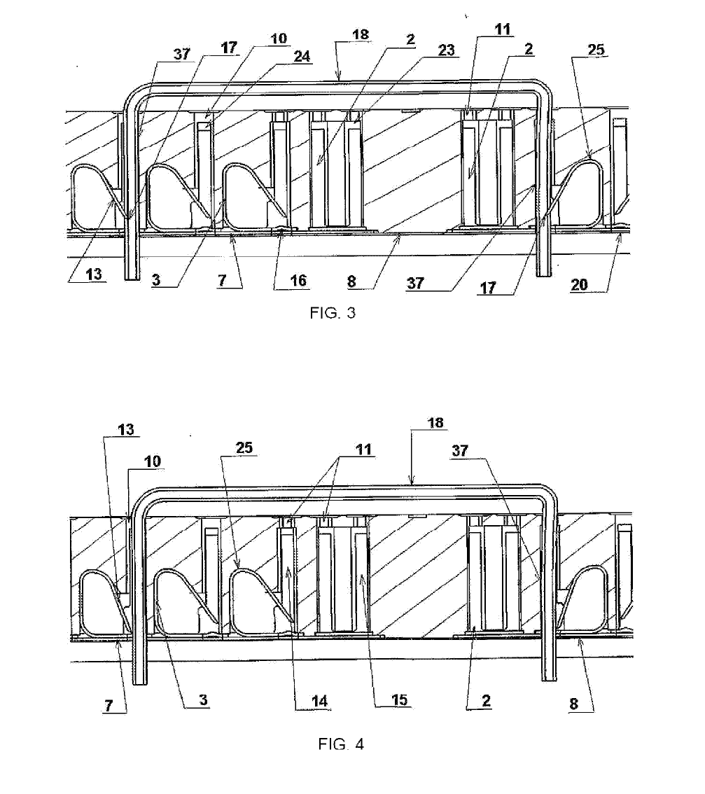

FIG. 3 shows a copper wire bridge (18), which may be also a cable, with sheath (41) inserted into a large size access borehole (10), and its other end inserted into a regular size access borehole (11). The copper wire bridge (18) has recesses (17) at its ends made by the action of inserting the bridge ends (18) with their sheath (41) into large size access boreholes (10) or those of regular size (11) over the card. Each end when inserted into the hole (10 ó 11) tends to move against the opposite blade wall (13), which is part of the stretched cable (37) guide groove. Advantage is taken of the fact that sheath material (41) is quite less hard than the ratchet mechanism blade (13) material pressing the bridge (18) with sheath (41) against the stretched cable (37) guide groove wall; the sharp corner in this state presses the sheath (41) without incrusting therein and thus not causing a cut. Said state remains until the bridge (18) with sheath is pulled, so that the ratchet mechanism blade (13) sharp corner is incrusted into the sheath (41) at each bridge end (18) due to hardness differences and causing a cut in said sheath. By having a cut in the sheath (41) and continuing pulling the bridge (18) in opposite direction to that from initial insertion, the uncut sheath part (41), having sufficient material for contacting the blade face, pushes upwards the ratchet mechanism blade (13), this in conjunction with the opposite reaction in the C-shaped connector (25) housing subcavity, the ratchet mechanism blade (13) is incrusted into the copper cable bridge forming a recess (17) at each end. Upon being the C-shaped connector (3) and the bridge (18) of conductive materials an electric connection is performed between said components and an electric connection in turn is performed between the two corresponding terminal lines. In order to properly perform this operation, each bridge end (18) with sheath (41) passes through the C-shaped connector guide borehole (16), also through the guide borehole in the sheet short-circuiting the connectors in terminal (19) or power (42) distribution accordingly, and through the insulating closure hole (20), before pulling said bridge (18) with sheath (41) in opposite direction to that from initial insertion. Each bridge end (18) with sheath (41) has sufficient rigidity to be inserted by the corresponding access borehole and pushed by the still non-inserted part of the bridge itself (18) so that the C-shaped connector clamps (14) are temporarily deformed at each end and the ratchet mechanism blade (13), those which may return to their original shape provided the material shape memory and the C-shaped connector (3) housing and opening groove design (24) and also the C-shaped connector housing subcavity (25) exerting reaction forces in the required points for recovering C-shaped connector (3) its original shape upon performing its function.

In FIG. 4, a copper wire bridge (18) is shown which may be also a cable, with sheath (41) inserted into large size access boreholes each of its ends. In the Figure the copper wire bridge (18) is shown inserted into the boreholes (10) those which may be also of regular size (11), without said bridge (18) having cuts in the sheath (41) neither recesses in the conductive cable or wire. This condition is present prior to pulling upwards the bridge (18) with sheath (41) to perform the cut in said sheath (41) and the recess (17) in the bridge (18) according to the teachings of methods in present application. This condition in turn prevents that the user cuts the cable bridge (18) to the measure corresponding to the two elements to be interconnected, prior to inserting said bridge (18) ends. This figure illustrates the state where the user may insert the bridge (18) passing each bridge end (18) through the boreholes (10), through the C-shaped connector guide borehole (16), through the guide borehole of the element short-circuiting the connectors in terminal arrangement (19) or through the guide borehole of the element short-circuiting the connectors in power arrangement (42) and through the hole in the insulating bottom closure (20) and then pulling the hole protruding ends in the insulating bottom closure in direction from card upper to bottom surface. This condition is present until the fact of pulling each bridge end (18) prevents a longer advancement of each one in the pulling force direction, by having a similar state to that of pulling in the same direction parallel ends in a rope in a pulley system. The ratchet mechanism blade (13) at each bridge end (18) pushes said sheath ends (41) against the pared the guide groove (37) without the sharp corner in the ratchet mechanism blade (13) cutting the sheath (41).

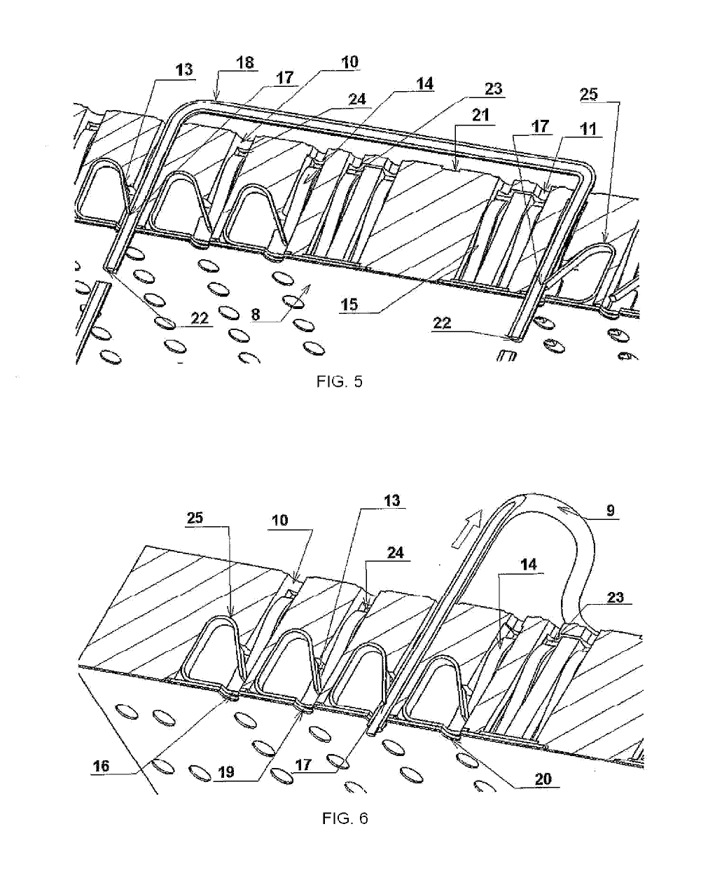

FIG. 5 shows a copper wire bridge (18), which may be also a sheathed cable (41) inserted in one end in a large size access borehole (10) and its other end in a regular size access borehole (11), both over the card surface. Remaining ends in excess are shown being removed wherein said removal may be performed with cutting clamps. This property is useful to provide fidelity in electric signals by having only the conductive cable necessary length between two terminals and also saving the time invested in measuring said distance between terminals. That above is achieved by passing bridge ends (18) with sheath (41) to each end by large size (10) or regular size (11) access boreholes, through the C-shaped connector guide borehole (16), through the guide borehole of short-circuiting element to connectors in terminal arrangement (19) or through the guide borehole of short-circuiting element to connectors in power arrangement (42) and through the hole in the insulating bottom closure (20), then pulling the hole protruding ends in the insulating bottom closure in direction from card upper to bottom surface. This condition is present until the fact of pulling each bridge end (18) prevents a longer advancement of each one in the pulling force direction, by having a similar state to that of pulling in the same direction parallel ends in a rope in a pulley system, then pulling later the upper part of the arc formed in the bridge from bottom to upper card surface so that the ratchet mechanism blade (13) pushing each bridge end (18) against the guide groove (37) within the casing will perform a cut in the sheath (41) and will form a recess (17) in each bridge end (18) in case of continuing pulling in such direction then each remaining and protruding end from the insulating bottom closure (20) is cut in such state in order to leave the minimum possible distance between already interconnected terminals by the C-shaped connector (3) ratchet mechanism blade (13) made of conductive material.

In FIG. 6 the wire end (9) is shown, which may be also a cable, with sheath (41) inserted into a large size access borehole (10) which may be also of regular size (11), with the C-shaped connector (3) ratchet mechanism blade (13) cutting cable (9) sheath (41) and forming a recess (17) in said sheathed cable or wire (9). The cable or wire (9) with its sheath (41) in turn, passes through the C-shaped connector guide borehole (16), through the guide borehole of the short-circuiting element to connectors in terminal (19) or power (42) distribution and through the insulating bottom closure (20) hole. This cable or wire (9) in such described condition is being pulled from the bottom to the upper card surface in order stretch the cable or wire (9) so that the free end is connected to another terminal or for removing part of the sheath to uncover the wire conductive part (9) so that a voltage may be measured or a signal may be inserted in said node. This stretching is possible because of the recess (17) being in mechanical contact with the ratchet mechanism blade (13) and when being pulled by the cable (9) in the Figure arrow direction generating a force compressing the ratchet mechanism blade (13) as an opposite reaction force to the force caused by contact with the recess (17) and cable pulling (9) is generated in the other end. This reaction force in (25) combined with (17) makes that cable (9) is locked when trying to pull it in the arrow direction when a stress force is exerted in the cable or wire (9) with fingers, these tend to slide along cable or wire (9) sheath (41) because the force locking the cable or wire (9) is larger than that exerted by fingers when pressing the sheath (41); therefore, when going through cable or wire (9) length with fingers pressing with certain force and upon locking the cable or wire 9 in the other end, an stress making that cable or wire (9) with sheath is stretched is present and shaped optimally in order to select whether connecting the other end to the other terminal or removing the sheath (41) in order to perform voltage measurement or inserting a signal in that node.

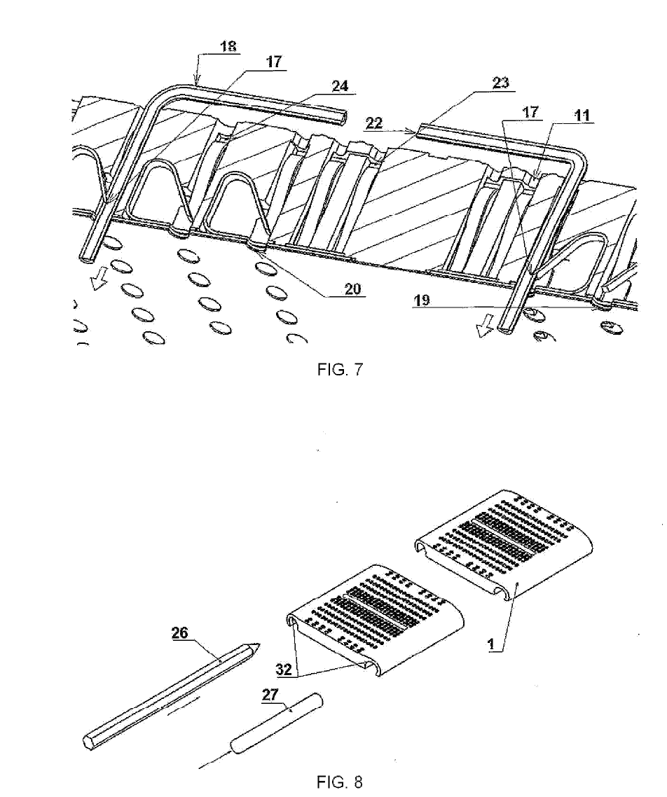

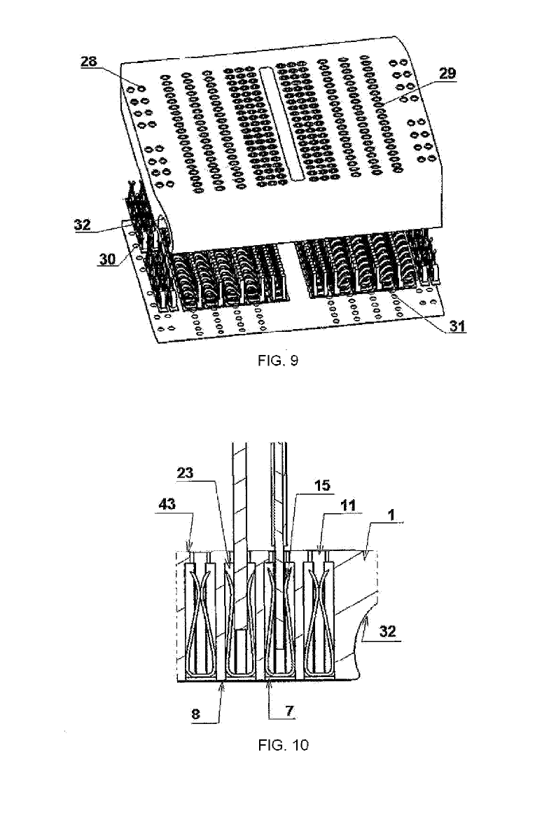

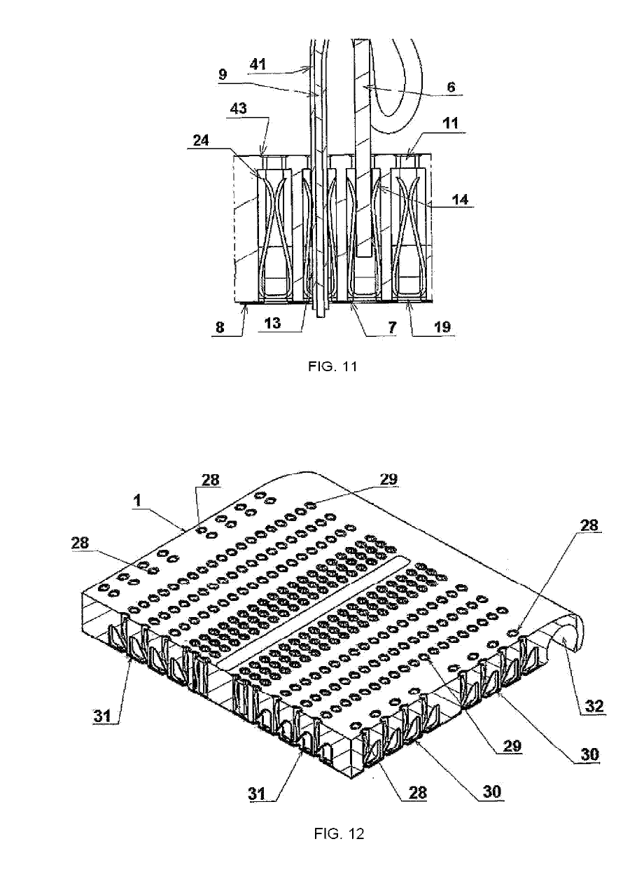

In FIG. 7, a copper wire bridge (18), which may be also a cable, with sheath (41) is shown inserted into a large size access borehole (10) end and another in a regular size access borehole (11), both over the card surface. Bridge upper part (18) is shown cut to allow pulling each now cut bridge end moving from card upper part to bottom part, in order to disassembly the connection between previously existing terminals. That above is provided by cutting the bridge (18) at any point of its visible part on card upper surface (1), each resulting part is pulled thereafter in arrow direction in Figure as there is no interlocking since although a recess (17) is present and this is in mechanical contact with (13), an opposite reaction force to pulling force in arrow direction is not present, given the formed mechanism arrangement. Therefore upon pulling any of two resulting cables, the force exerted by the C-shaped connector (3) ratchet mechanism blade (13) when tightening the cable against the guide groove (37), is not sufficient to stop the forward movement of cut cable through C-shaped connector guide borehole guide groove (37) and of the guide borehole short-circuiting to connectors in terminal (19) or power (42) distribution and the insulating bottom closure hole (20).

In FIG. 8 two cards (1) are shown being assembled passing a cylindrical (27) or near-cylindrical (26) body by the card (1) guides (32) running in their widest part in order to make a larger card for wiring circuits so required. The near-cylindrical body (26) may be a pen which length includes the width of two cards to be assembled; said body upon insertion into the collinear guides and in conjunction with another similar or cylindrical element (27) as those shown in the Figure is a sufficient and necessary condition to perform satisfactorily and assembly between two cards. Card material (1) has sufficient shape memory to press the cylindrical (27) or near-cylindrical (26) body with force in order to ensure a good assembly.

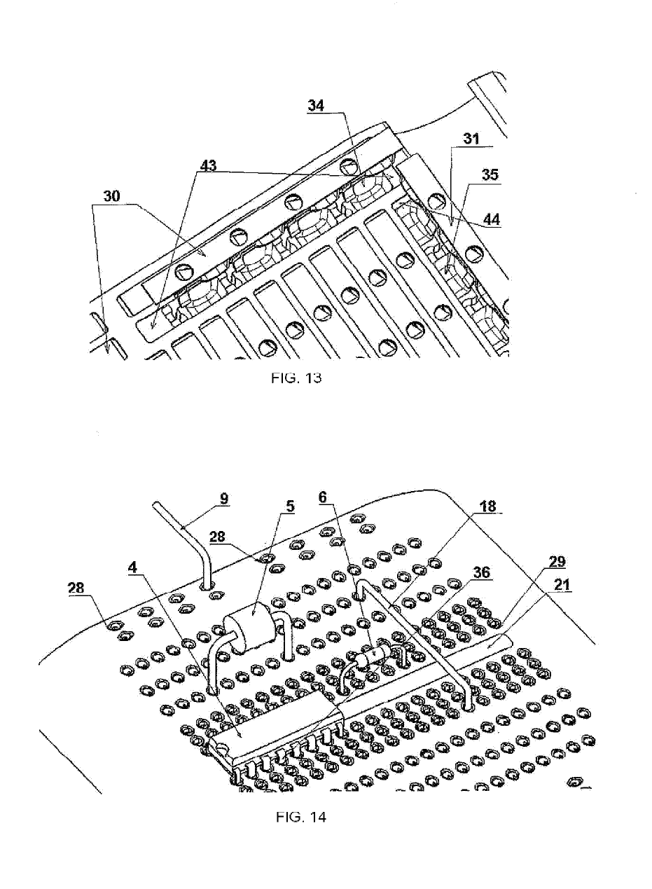

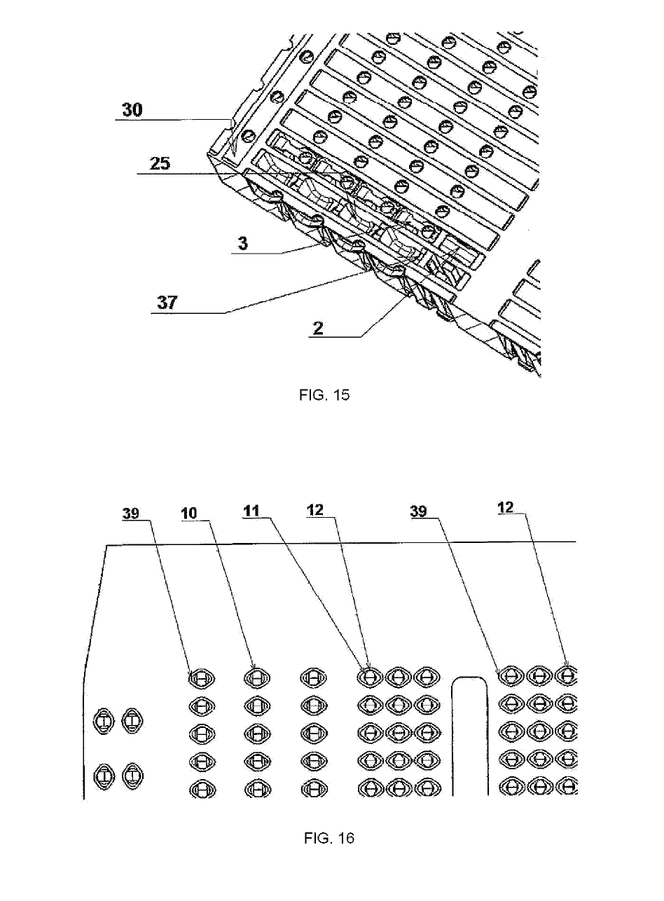

In FIG. 13 the free regions in the casing are shown for adhesion of the free regions in the terminal (44) and power (43) distribution line, in order to fix each respective line on site.

In FIG. 14, an IC (4) in the card upper part is shown with the leg widest parts inserted into the extension grooves (12) of the regular size access boreholes (11). IC legs (36) open the corresponding clamps of the similar but not identical connector to that from published patent Des. 235,554 (15) where they are connected.

In FIG. 16, bevel-edged diamond-shape surfaces (39) are shown in the card upper surface in order to enhance card aesthetics and making also that the action of inserting a cable or wire (9) with sheath (41) in a large size (10) or regular (11) el borehole is easier as the edges are bevel-edged (43), shown in FIGS. 10 and 11, leading from larger to smaller extension surface.

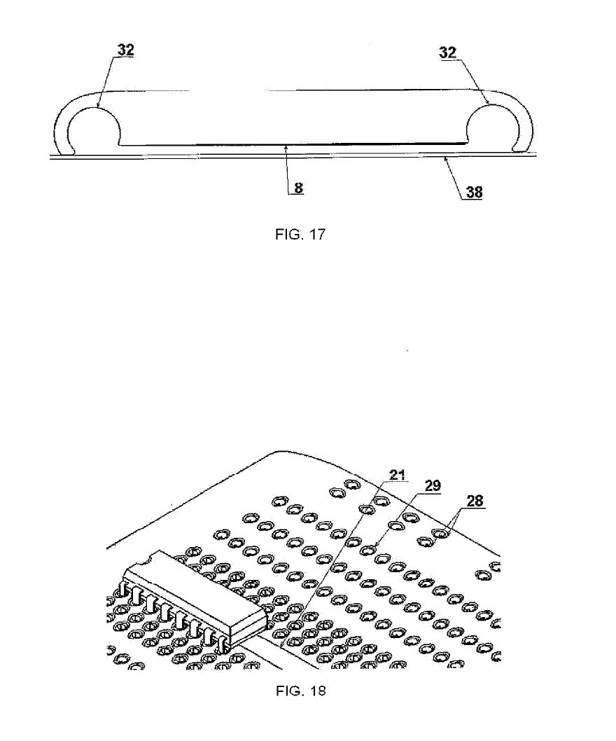

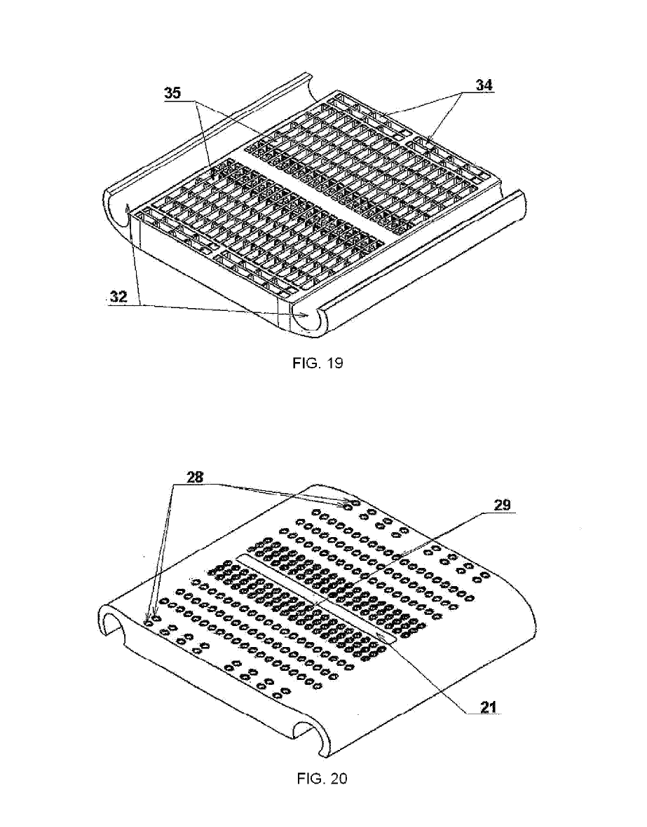

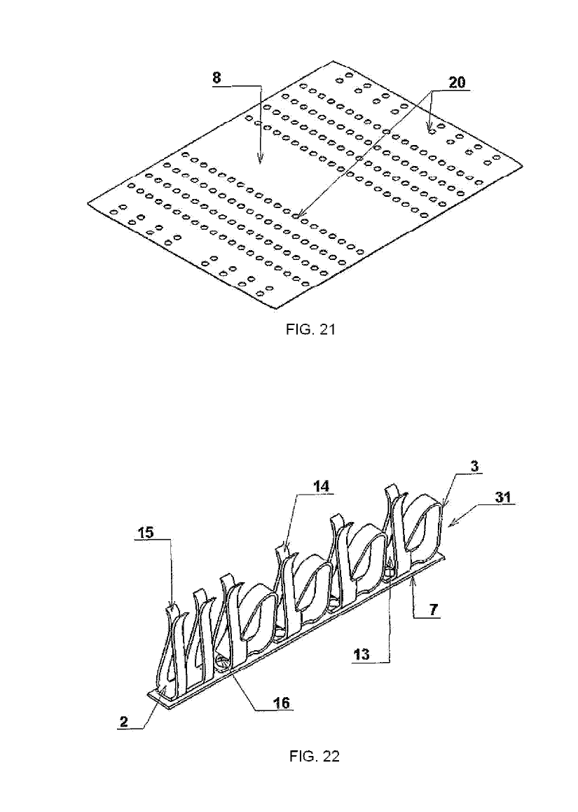

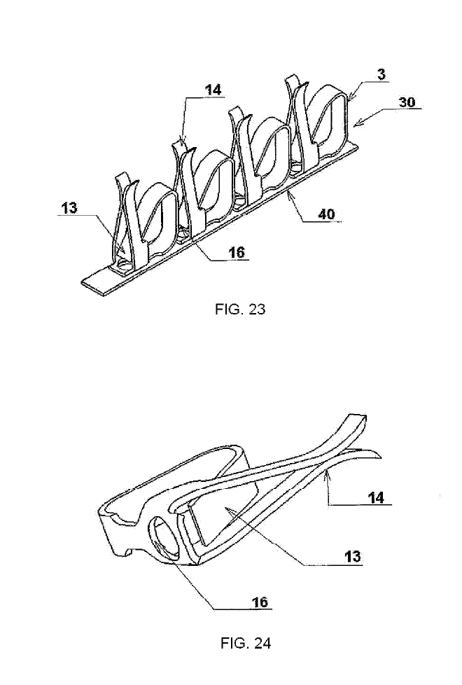

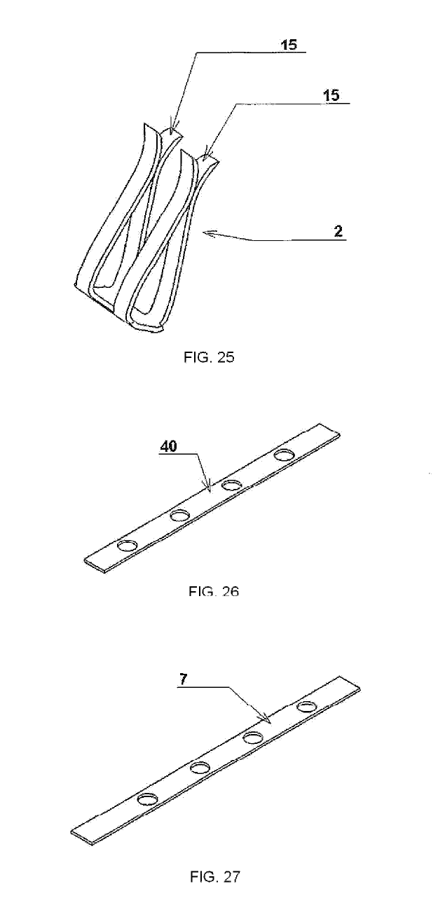

In FIG. 17 the card with the assembly guides (32) is shown supporting and separating it from the floor (38) preventing that the protruding cables from the holes in the insulating bottom closure (20) support the card load.

In FIG. 18 an IC (4) inserted into the card upper part is shown with its legs inserted into regular size access boreholes (11), the groove central (21) is useful for leveraging the groove bottom part with any thin and rigid long element in order to remove said IC (4) from the card.

1-36. (canceled)

37. An assembly method of two cards and one wiring on an electric and electronic component interconnection card, with insulated wire or cable, said method comprising:
inserting two ends of a sheathed wire or cable in boreholes in said card for suppressing a bridge length measurement to be connected,
electromechanically interconnecting one or two sheathed wire or cable ends with connection lines within the card,
pulling a sheathed wire or cable even in a connection by both ends and
releasing the interconnection between the one end or two ends of a sheathed wire or cable with connection lines within the card.

38. The wiring method according to claim 37, wherein inserting two ends of a sheathed wire or cable within boreholes in said card in order to suppress bridge length measurement to be connected comprises
inserting each end into said boreholes with access from an upper part of said card and into boreholes where user knows they are within the card body itself: bus or terminal lines with one ratchet mechanism blade per borehole;
passing each of said ends through the card body so that when passing simultaneously each of them a state is achieved when each cable or wire end is not possible to be pulled anymore below the card, because a state is achieved making impossible a longer forward movement of each end in the pulling force direction, having a similar analogy when pulling parallel rope ends in the same direction in a pulley system;
or such that upon inserting both ends and pulling and pushing only one of them, a longer forward movement is not possible by the fact that an electromechanical interconnection eventually is present (wherein interlocking opposition to the cable or wire stressing force in opposite direction to insertion is present) between one of cable or wire ends and a connection line (bus or terminal) through a ratchet mechanism blade;
cutting the protruding remains of sheathed wire or cable from card bottom surface boreholes so that they have only the minimum and necessary length to be interconnected, as a next step to that disclosed, two electric, electronic, node components or any combination of two of three mentioned, connected to bus or terminal lines in the card; having a cable or wire insertion within the card, this to move against the opposite wall of a ratchet mechanism blade given the latter inclination; the cable in turn at the time of insertion, makes that ratchet mechanism blade stores elastic potential energy when passing between said wall and the blade itself; in this state and in the state where cable or wire forward movement is stopped from upper part to bottom part card direction, a cut is not caused in the sheath nor in the recess in cable or wire copper part.

39. The wiring method according to claim 37, wherein electromechanically interconnecting one or two ends of a sheathed wire or cable, with connection lines within the card comprises
using a ratchet mechanism, said mechanism just allowing cable forward movement through a large or regular size borehole in the card, in a single direction, formed by pulling a cable or wire end with a sheath previously inserted into a large or regular size access borehole; advantage being taken in this method of the fact that the ratchet mechanism blade material pressing the cable or wire with sheath against the opposite wall to said blade, the cable or wire with sheath remaining between the blade and the wall, being much harder than cable or wire sheathing material; this allowing that when pulling said cable or wire in opposite direction to that from initial insertion combined with the potential energy stored in ratchet mechanism blade pressing its sharp corner against the sheath, causes a cut in said sheath; secondly by following pulling the cable or wire with sheath wherein the sharp corner bottom surface contacts the cable sheathing cut part, combined with a cable pulling action and combined with the force exerting the remaining potential energy of the ratchet mechanism blade over the cable, causing that the ratchet mechanism blade still penetrates towards cable direction until contacting the copper part; thirdly, by continuing pulling the cable or wire with sheath wherein the bottom part of the sharp corner contacts the sheath cut part, combined with a cable or wire pulling action from card bottom to upper part, combined with the force exerted by the elastic potential energy in the ratchet mechanism blade over the cable conductive part, combined with the opposite reaction force of a sub-cavity housing a C-shaped connector on the sheath cut part over the sharp corner bottom surface, creating a recess in the cable conductive part, being of a softer material than the ratchet mechanism blade; upon pulling the cable or wire with the fingers a sliding is caused between said fingers and the sheath serving for grasping the cable at the time of causing a deep recess, this event depends on the tightening sheath force with user fingers; consequently the cable or wire forward movement in opposite direction to that from initial insertion is stopped; in fourth place, upon stopping forward movement, remaining potential energy in the ratchet mechanism blade pressing the cable or wire with sheath against an opposite wall to said ratchet mechanism blade, keeps an electromechanical contact between the conductive ratchet mechanism blade and the copper conductive part; the electromechanical connection mechanical arrangement restricts cable with sheath movement in any direction, except for an orthogonal direction line from card upper to bottom part; all above constituting said method useful for performing an electric interconnection between two electric, electronic, node components or any combination of those three, assembled over a card surface through an insulated copper wire bridge, inserted into boreholes located on said surface.

40. The wiring method according to claim 37, wherein said sheathed wire or cable stretching step when referred to a single end interconnection, is characterized by performing the procedures or steps disclosed in claims 38 and 39 in addition to continue with cable pulling with fingers, so that said cable is straightened by the stressing action on the interlocked cable in one of the ends by the ratchet mechanism following the sheathed wire or cable body length pressing with the fingers; this leading to a finger-pulled end ready to perform a connection, a voltage measurement bridging or signal insertion into a connection line and then to a connected element therein, where said cable or wire other end has been connected.

41. The wiring method according to claim 37, wherein said interconnection release step between one end or two ends of a sheathed wire or cable with connection lines within the card, is characterized by cutting the cable bridge or wire interconnecting the two interconnection constituting elements on the middle and visible section over the card upper surface, wherein their ends are electromechanically connected to two lines (bus or terminal) separated each other through one of their respective ratchet mechanism blades; the user passing the resulting cut sheathed cables or wires through the boreholes where initially inserted in a direction from card upper surface to card bottom part taking advantage of above mentioned featured cable forward movement not being interlocked by the ratchet mechanism, so that each resulting cable is removed from the card and said previously used boreholes are ready to perform another interconnection; having only one electromechanical connection in one of the sheathed wire or cable ends, said end is just pulled in a direction from the card upper surface to the card bottom part.

42. The assembly method of two cards according to claim 37, wherein said assembly method comprises passing each of two cylindrical or near-cylindrical bodies, through lugs or guides at casing side of each card wherein the two lugs in one card are aligned with other corresponding two in another card; said cylindrical or near-cylindrical bodies are pressed by cumulated potential energy in each card plastic, as the hemi-circumference radius in the lugs is slightly more reduced than cylindrical body circumference radius and also slightly smaller than polygon surrounding circumference of a near-cylindrical body, which may be a common pen.

43. An electric and electronic component interconnection card with insulated wire or cable, said card comprising a multiple connection line insulating casing for power arrangement, terminal arrangement multiple lines and a bottom part insulating sheath, wherein said terminal and power arrangement lines comprise ratchet mechanism blades that in conjunction with each ratchet mechanism blade opposite wall and in conjunction with an insulated wire or cable, inserted through card upper part down to such depth traversing said interconnection card body and then pulled in opposite direction to prior insertion, a ratchet mechanism is formed, so that by this formed mechanism action said blade penetrates the sheath or insulator and forms a recess in the conductive material, then an electromechanical connection is accordingly generated by ratchet mechanism blade contact with wire because both are of conductive material.

44. The electric and electronic component interconnection card, with insulated wire or cable according to claim 43 wherein the insulating casing is characterized by having access boreholes to connector line housings of two types, terminal and power, located within the body thereof, said boreholes going directly to the fixing clamps at each of the connectors in each line.

45. The card comprising an insulating casing according to claim 44 wherein said access boreholes are disposed in two arrangement types: terminal and power; the power arrangement comprises multiple alignments comprising exclusively large size multiple access boreholes, these alignments are aligned in rows located in the card ends in parallel subgroups in longitudinally arranged pair rows, wherein each row in a subgroup is transversely separated each other at 2.54 mm; in the two row subgroup one of them is intended to be a ground connection set and the other the power; boreholes in each arrangement enter into the power line housed in a cavity, wherein said line exclusively comprises conductive plated-material, shape memory, C-shaped connectors (one connector per each access borehole), separated 5.08 mm each other as per their boreholes along said alignment and short-circuited among them by a conductive element made of the same plated material; row subgroups in this arrangement are symmetrically repeated with respect to a card imaginary plane cutting it evenly with respect to its length; the terminal arrangement comprises parallel separated spaced multiple alignments at 2.54 mm comprising regular and large multiple access boreholes, wherein each regular size borehole subgroup is separated from those of large size in 5.08 mm respectively with respect to their centers; said boreholes enter into lines comprised of C-shaped connectors, which fixing clamps are separated each other at 5.08 mm, and a similar connector to that from prior art, all made of conductive plated material and with shape memory, in short-circuit among them by a conductive element made of the same plated material; this arrangement being symmetrically repeated with respect to a card imaginary plane cutting the same evenly with respect to its length, said plane located at 3.81 mm from the center of respective first card accesses at each side from center towards outside thereof.

46. The card comprising insulating casing according to claim 44, wherein said access boreholes are of two sizes: one of large size being designed for inserting therein components with thick legs not easily entering into prior art wiring card and regular size access boreholes designed to insert therein medium thickness leg components.

47. The card with regular size access boreholes according to claim 46, comprising extension grooves for inserting integrated circuit leg widest part into plastic enclosures.

48. The electric and electronic component interconnection card, with insulated wire or cable according to claim 43, wherein the insulating casing is further characterized by having housing cavities where lines comprising C-shaped connectors in short-circuit among them are assembled (connection line in power arrangement) and lines comprising C-shaped connectors and similar to those from prior art (connection line in terminal arrangement).

49. The card comprising an insulating casing according to claim 48, wherein the cavities are of two types, each by arrangement type: one cavity for power arrangement line wherein each sub-cavity house a single C-shape connector having large size access boreholes; the terminal arrangement cavity type having sub-cavities in three types: single type multiples for housing one C-shaped connector each with large size access boreholes, another type for housing a C-shaped connector with regular size access borehole and extension grooves for inserting the widest part of the integrated circuit legs into plastic enclosures and one of another type for housing a similar connector to that from prior art, with regular size access boreholes and extension grooves for inserting the integrated circuit leg widest part into plastic enclosures.

50. The card comprising cavities in its insulating casing as disclosed in claim 49, wherein cross-section of said sub-cavities is for C-shaped connectors, this may have a large ore regular access borehole, with ratchet mechanism blade curvature shape of C-shaped connector so that C-shaped connectors perfectly seat on their site and then, clamp edges seat in side housing grooves.

51. The card comprising cavities in its insulating casing according to claim 49, wherein the C-shaped connector housing sub-cavity, being located in the housing cavities for housing terminal arrangement lines and power arrangement lines is characterized by having three properties: one following a ratchet mechanism blade curvatures in the C-shaped connector and which radiuses are designed to dissipate potential power stored in said connector thus being possible for the latter to recover its shape prior to a copper wire bridge insertion; the other property being a groove wherein the C-shaped connector clamp is housed, having a parallelepipedal shape with two proper nearly-cylindrical guide grooves for sheathed copper wire; the third property is a guide cavity for the copper wire bridge forming a split pipe by a parallelepiped housing a C-shaped connector clamp and having in its upper part a borehole which radius is of the same size than the pipe, such as forming a C-shaped connector housing with large size access borehole.

52. The card comprising cavities in its insulating casing as indicated in claim 49, wherein the C-shaped connector housing sub-cavity which is only present in the housing cavity for the terminal arrangement line, is characterized by having those same three properties than the housing sub-cavity disclosed in claim 51 but instead upper part borehole is of regular size, said borehole comprising also its respective extension grooves.

53. The card comprising cavities in its insulating casing as disclosed in claim 49, wherein the housing sub-cavity of a connector similar but not identical to that from prior art, only present in the line housing cavity in terminal arrangement, is characterized by having two parallelepipedal bodies in contact with the connector, those not interfering with the electronic component connection and each one located at each void parallelepiped cross wall forming the housing sub-cavity of this connector type and two nearly-parallelepipedal bodies with a hemi-cylindrical groove running therein being an extension of a borehole located at card upper part; said nearly-parallelepipedal bodies are located at each void parallelepiped longitudinal wall forming the housing sub-cavity of this type of connector.

54. The card comprising an insulating casing according to claim 48, wherein the terminal arrangement line housing cavity within its body comprises three sub-cavities disclosed in claim 51, one disclosed in claim 52 and one disclosed in claim 53 and thus having an embossed shape similar to that of an element short-circuiting the connectors in its bottom part for housing it, in the terminal arrangement line type.

55. The card comprising an insulating casing according to claim 48, wherein the power arrangement line housing cavity comprises multiple sub-cavities within its body disclosed in claim 51 and thus having an embossed shape similar to that of an element short-circuiting the connectors in its bottom part for housing it, in the power arrangement line type.

56. The electric and electronic component interconnection card, with insulated wire or cable according to claim 43, wherein the line type in power arrangement comprises multiple C-shaped connectors made of conductive material, plated and with shape memory, arranged in a line such that each is separated at 5.08 mm each other with respect to a fixing clamp in its geometry and also being short-circuited through a component made of conductive material, with shape memory and plated, in such arrangement that said multiple C-shaped connectors are in series keeping their orientation along the line and which central imaginary plane cutting symmetrically said C-shaped connector, matches with an imaginary plane cutting by its longest side and symmetrically the element short-circuiting to the multiple C-shaped connectors.

57. The card wherein its power arrangement type line according to claim 56, further characterized by matching between the axis in multiple guide boreholes arranged along the element short-circuiting to multiple C-shaped connectors and which number is similar as the number of said C-shaped connectors, and above mentioned guide boreholes in the body of each of said C-shaped connectors.

58. The card wherein its line type in power arrangement according to claim 56, further characterized by multiple C-shaped connectors that are assembled to the short-circuiting element through contact coupling, welding or metallographic riveting and wherein line length in power arrangement and thus the number of C-shaped connectors to be short-circuited varies in a direct relationship with casing length which cavities house said power arrangement line types.

59. The electric and electronic component interconnection card, with insulated wire or cable according to claim 43, wherein the line type in terminal arrangement comprises multiple C-shaped connectors made of conductive material, plated and with shape memory, arranged in one line such that each is separated at 5.08 mm each other with respect to a fixing clamp in its geometry and a similar connector to that from prior art with two fixing clamps separated 2.54 mm each other; this connector similar to that from published patent Des. 235,554 separated at 2.54 mm with respect to one of its clamps and to closest C-shaped connector clamp; in the light of above, there are multiple clamps, three of them separated at 2.54 mm to each other and others forming another clamp subgroup separated from those three first at 5.08 mm; each clamp separates from each other at 5.08 mm in this group; said connectors are short-circuited through an element made of conductive material, with shape memory and plated, in such arrangement that C-shaped connectors are in series keeping their orientation along the line and which central imaginary plane symmetrically cutting said C-shaped connector, matches with an imaginary plane cutting at its longest side and symmetrically to the element short-circuiting to C-shaped connectors and similar to those from prior art.

60. The card wherein its line type in terminal arrangement according to claim 59 is further characterized by matching between axis in four arranged along the short-circuiting element for multiple connectors, and above mentioned guide boreholes in the body of each C-shaped connector; being also located a similar connector to that from prior art with a central imaginary plane cutting symmetrically said connector in its longest part in a region without any borehole, matching with the imaginary plane cutting in its longest side and symmetrically a short-circuiting element for multiple connectors; also the short-circuiting element for five connectors and forming the line having free regions at the ends and one in a part between the closest C-shaped connector to a connector similar but not identical to that from published patent Des. 235,554.

61. The card wherein its line type in terminal arrangement according to claim 59, is further characterized by connectors of two types being assembled to the short-circuiting element by contact coupling, welding or riveting and where the number of terminal arrangement lines varies in direct relationship with the casing length which cavities house these types of terminal arrangement lines.

62. The card with its power arrangement line according to claim 56, wherein the terminal arrangement lines, have a line type that comprises multiple C-shaped connectors made of conductive material, plated and with shape memory, arranged in one line such that each is separated at 5.08 mm each other with respect to a fixing clamp in its geometry and a similar connector to that from prior art with two fixing clamps separated 2.54 mm each other; this connector similar to that from published patent Des. 235,554 separated at 2.54 mm with respect to one of its clamps and to closest C-shaped connector clamp; in the light of above, there are multiple clamps, three of them separated at 2.54 mm to each other and others forming another clamp subgroup separated from those three first at 5.08 mm; each clamp separates from each other at 5.08 mm in this group; said connectors are short-circuited through an element made of conductive material, with shape memory and plated, in such arrangement that C-shaped connectors are in series keeping their orientation along the line and which central imaginary plane symmetrically cutting said C-shaped connector, matches with an imaginary plane cutting at its longest side and symmetrically to the element short-circuiting to C-shaped connectors and similar to those from prior art, wherein the C-shaped connector is characterized by being made of conductive material, plated, with shape memory, and constituted by three main elements: fixing clamps, ratchet mechanism blade and guide borehole.

63. The card with a connector as disclosed in claim 62, wherein the ratchet mechanism blade comprises a sharp corner and with bend radiuses constituting a curvature in the geometry thereof and wherein said radiuses are designed for dissipating the stress exerted by deforming said blade upon inserting copper wire or cable bridges with insulating sheath.

64. The card with a connector as disclosed in claim 62, wherein said fixing clamp comprises two curved side elements in opposite position wherein the curvature in the geometry of each element has radiuses designed for dissipating a deformation stress upon inserting several sheathed wire or cable electric, electronic components and bridges.

65. The card with connector as disclosed in claim 62, wherein its guide borehole traverses the hemi-flat region located between the fixing clamp constituting elements; being supported with a square section in the material for this purpose as the region size between clamps is not sufficient for housing said borehole.

66. The card with a line in terminal arrangement as described in claim 59, wherein a connector similar to that from prior art is made of conductive material, plated and with shape memory, made of a single piece and formed with two fixing clamps, each one comprising two curved, symmetrical and opposed side elements, wherein said curvature in each one geometry has radiuses designed for dissipating the stress exerted by deformation upon inserting several non-sheathed wire or cable and electric, electronic components.

67. The card with a line in power arrangement as described in claim 56, wherein the conductive element, plated, with shape memory and made of a single piece is characterized by short-circuiting to multiple C-shaped connectors and by having multiple boreholes in its body with a number equivalent to that of the connectors to be assembled on its surface by contact coupling, welding or riveting, said boreholes traversing from the upper to the bottom face and separated in turn at 5.08 mm each other and such positioned in their axes matching with a plane cutting to said short-circuiting element symmetrically in its longest part; this element also having free regions at the ends for assembling through adhesion a line formed by the action of short-circuiting the connectors to the insulating material casing.

68. The card with a line in terminal arrangement as described in claim 59, wherein the conductive element, plated, with shape memory and made of a single piece, is characterized by short-circuiting to multiple C-shaped connectors and one similar to that from prior art, those which are to be assembled in their surface by contact coupling, welding or riveting, the boreholes traversing towards a short-circuiting element from its upper to bottom surface and also separated at 5.08 mm each other and such positioned that their axes match with a plane cutting said short-circuiting element symmetrically in its longest part; a flat region also designed on its surface for housing a connector similar to that from prior art.

69. The electric and electronic component interconnection card, with insulated wire or cable according to claim 43, wherein the insulating casing is characterized by having lugs located at the ends running all cross present card for assembling other same sized cards that in such case house cylindrical or other near-cylindrical bodies which may be comprised of pencils or pens wherein said lugs make a separation of the card bottom surface from the resting surface in order to make that protruding parts from connection wire bridges in the bottom part do not support the wiring card and to separate it from the support surface.

70. The electric and electronic component interconnection card, with insulated wire or cable according to claim 43, wherein the insulating casing is characterized by having diamond-shape embosses with a longer axis being aligned with respect to each respective alignment for each whether terminal or power arrangement and with axis intersection matching with the access borehole axes for connector line housings being characterized by enhancing card aesthetics and also making that the insertion action of a cable with sheath into the respective borehole is easier as the edges are bevel-edged leading from a larger extension surface to a smaller extension one.

71. The electric and electronic component interconnection card, with insulated wire or cable, as claimed in claim 43, wherein the sheath being adhered to the card bottom part is made of insulating material and keeps connector lines from exposure and having also outlet boreholes for copper wire bridges following an identical arrangement to that of the upper surface casing boreholes in a card made of insulating material; when assembled, boreholes in this sheath match with the boreholes in the card upper part.

72. The wiring card of claim 43, further characterized by allowing the user to identify what clamp of what connector type will be receiving the electric or electronic component terminal leg so that the user may insert fully confident the component when being a connector similar to that from prior art or otherwise when dealing with a C-shaped connector thus attending to insert the component terminal leg in the clamp located above the ratchet mechanism blade in a C-shaped connector and not passing said leg through said ratchet blade as the pulling action for moving back the component when making this mistake would cause a possible failure in the ratchet mechanism blade in said C-shaped connector.
